(19) United States
(12) Patent Application Publication
(10) Pub. No.: US 2016/0034411 A1
(43) Pub. Date: Feb. 4, 2016

(54) Subsystem Peripheral Ownership Scheduling and Reconfiguration for Highly Integrated System on Chips

(71) Applicant: Qualcomm Innovation Center, Inc., San Diego, CA (US)

(72) Inventors: Kevin Smith, San Diego, CA (US); Phong Thanh Duong, San Diego, CA (US)

(21) Appl. No.: 14/632,936

(22) Filed: Feb. 26, 2015

Related U.S. Application Data
(60) Provisional application No. 62/032,851, filed on Aug. 4, 2014.

(51) Int. Cl. G06F 13/40; G06F 15/78; G06F 9/54; G06F 13/364; G06F 13/42

(52) U.S. Cl. CPC G06F 13/4022; G06F 13/364; G06F 13/4072; G06F 13/4282; G06F 9/547; G06F 15/7817

(57) ABSTRACT

Herein disclosed are systems, methods, and apparatus for dynamic switching of bus ownership, and in particular, for dynamic switching of peripheral bus ownership as well as all subsystems and/or peripherals on the bus. A peripheral bus access manager is distributed across multiple subsystems and controls access to a peripheral bus controller. The peripheral bus access manager also determines which subsystem should own the bus and then arbitrates access to the peripheral bus controller in order to indirectly make a desired subsystem the peripheral bus owner.

### CROSS REFERENCE TO RELATED APPLICATIONS

The present application for patent claims priority to Provisional Application No. 62/032,851 entitled “Subsystem Peripheral Ownership Scheduling and Reconfiguration for Highly Integrated SOCs” filed Aug. 4, 2014, and assigned to the assignee hereof and hereby expressly incorporated by reference herein.

### BACKGROUND

1. Field of the Disclosure

The present disclosure relates generally to a system on chip, and more specifically to configuring a sensor/peripheral bus in a system on chip.

2. Description of Related Art

Today's system on chip (SOC) devices can comprise numerous discrete processors or subsystems able to communicate with each other via one or more communication channels called buses. Often, multiple subsystems have access to a single bus and to avoid multiple simultaneous attempts to use or control the bus, arbitration schemes can be used to determine which subsystem controls the bus at a given time (this architecture is known as a “shared bus”). For instance, in the Inter-Integrated Circuit (I²C) bus, a component on the bus that wishes to take control of the bus looks to see if the data line of the bus is being driven low, and if so, this component knows that another component is already controlling the bus, and therefore waits until the other component releases control. If the line is high, then a component knows that it is free to take control of the bus. When two components attempt to control the bus at the same time, more sophisticated arbitration schemes are needed, and these are often managed by a bus controller.

When a subsystem is given control of the bus it typically initiates communication with other devices on the bus and generates the bus clock. The controlling subsystem can be referred to as the “master” and other subsystems on the bus, those receiving the clock and responding when addressed by the master, can be referred to as “slaves.” For instance, an application processor on a smart phone can control a bus that links it to the modem processor and can pass a request to the modem processor to transmit data representing a TWITTER TWEET to remote TWITTER servers.

Existing bus architectures are typically centralized or distributed. Centralized architectures include a bus controller that determines which subsystem will have control of the bus. In a distributed architecture, this role is spread amongst the subsystems on the bus. In other words, in a centralized system, the bus controller tells each of the subsystems which one has control of the bus, whereas in a distributed system, the subsystems themselves communicate with each other and follow a protocol to ensure that only one subsystem controls the bus at a time.

### SUMMARY

Embodiments disclosed herein address the above stated needs by providing a peripheral bus access manager that controls access to the peripheral bus controller and thereby dictates the master of the peripheral bus by only allowing one subsystem to access the peripheral bus controller at a time.

One aspect of the disclosure is a system-on-chip (SoC) arbitrating access to a peripheral bus controller, the SoC including a peripheral bus controller, a first and second subsystem, a first instance of a peripheral bus access manager, a second instance of a peripheral bus access manager, and a non-transitory, tangible computer readable storage media, encoded with processor readable instructions on the first and second instances of the peripheral bus access manager. The peripheral bus controller can be responsible for managing data flow on a peripheral bus. The first and second subsystems can be coupled to the peripheral bus by the peripheral bus controller. The first subsystem can initially have exclusive access to the peripheral bus and thereby process data from one or more peripherals on the peripheral bus. The first instance of the peripheral bus access manager can be included on the first subsystem. The second instance of the peripheral bus access manager can be included on the second subsystem. The first and second instances can include a non-transitory, tangible computer readable storage media, encoded with processor readable instructions to perform a method for dynamically selecting which one of the first and second subsystems has access to the peripheral bus controller. The method can include passing a request from the first subsystem to the second subsystem requesting that processing of the data from the one or more peripherals be switched to the second subsystem. A path of the request circumvents the peripheral bus controller. The method can further include switching access to the peripheral bus controller from the first subsystem to the second subsystem, in response to the request, such that processing of the data from the one or more peripherals switches to the second subsystem.

Another aspect of the disclosure is a method for arbitrating subsystem access to a peripheral bus controller. The method can include managing, via a peripheral bus controller, data flow on a peripheral bus between a first subsystem and one or more peripherals. The method can further include processing data on the first subsystem from the one or more peripherals. The method can yet further include requesting that the processing be switched to a second subsystem, and passing this request via a remote procedure call to the second subsystem via a path that circumvents the peripheral bus controller. Additionally, method can include switching access to the peripheral bus controller from the first subsystem to the second subsystem. Further, the method can include processing data on the second subsystem from the one or more peripherals.

One aspect of the disclosure is a non-transitory, tangible computer readable storage medium, encoded with processor readable instructions to perform a method for arbitrating subsystem access to a peripheral bus controller. The method can include managing, via a peripheral bus controller, data flow on a peripheral bus between a first subsystem and one or more peripherals. The method can further include processing data on the first subsystem from the one or more peripherals. The method can yet further include requesting that the processing be switched to a second subsystem, and passing this request via a remote procedure call to the second subsystem via a path that circumvents the peripheral bus controller. Additionally, method can include switching access to the peripheral bus controller from the first subsystem to the second subsystem. Further, the method can include processing data on the second subsystem from the one or more peripherals.

### BRIEF DESCRIPTION OF THE DRAWINGS

FIG. 1 illustrates a functional diagram of a system including a SoC having the herein disclosed functionality as well as one or more peripherals coupled to the SoC via a peripheral bus;

FIG. 2 illustrates a system diagram showing the various components implemented to carry out the functionality described in FIG. 1;

FIG. 3 illustrates a further embodiment of a SoC that can dynamically switch peripheral bus ownership;

FIG. 4 illustrates a state diagram for a first and second subsystem as envisioned by this disclosure;

FIG. 5 illustrates another system diagram for an embodiment to carry out the functionality described relative to FIG. 1;

FIG. 6 illustrates yet another system diagram for an embodiment to carry out the functionality described relative to FIG. 1;

FIG. 7 illustrates yet a further embodiment of a SoC that can dynamically switch bus ownership;

FIG. 8 illustrates a method of switching ownership of a bus where a master is selected from two or more subsystems and another subsystem(s) or peripheral(s) is(are) the slave;

FIG. 9 illustrates an alternative method to the method 800 shown in FIG. 8;

FIG. 10 illustrates a stack diagram of a system comprising a peripheral bus access manager controlling access to a peripheral bus controller based on analysis of system information not available to the peripheral bus controller;

FIG. 11 illustrates a functional diagram of a system including a SoC coupled to one or more peripherals according to an embodiment well known to those of skill in the art; and

FIG. 12 illustrates a diagrammatic representation of one embodiment of a computer system within which a set of instructions can execute for causing a device to perform or execute any one or more of the aspects and/or methodologies of the present disclosure.

### DETAILED DESCRIPTION

### Definitions

For purposes of this disclosure, a “master” issues requests to a bus and slaves serve those requests. For instance, one processor may request an update from a slave and the slave responds by providing the update via the bus.

For purposes of this disclosure, a “master of the bus” is a subsystem having control over a peripheral bus or internal bus. The master of the bus can switch between subsystems, and typically the master upon startup determines which other subsystem(s) becomes the master of the bus, and when the master role switches back to the subsystem that originally owned the bus.

For the purposes of this disclosure, a “bus” is hardware that passes data between two nodes or subsystems. Nodes that can be coupled to a bus include processors, sub-systems, and controllers, among others.

For the purposes of this disclosure, a “peripheral bus” is a bus that communicates with hardware external to the SoC. However, as more and more peripherals are incorporated onto the SoC rather than external thereto, in some embodiments the peripheral bus can couple to hardware on the SoC. Over time, the distinction between a peripheral bus and an internal bus will likely gradually blur.

For the purposes of this disclosure, a “subsystem” is a node that couples to a bus. Examples include a multicore subsystem comprising one or more central processing units, and one or more levels of cache memory. A modem and GPS can comprise another subsystem, while a GPU, audio/video accelerators, a DSP, and a multimedia processor can be part of a multimedia subsystem. These are just a few non-limiting examples.

For the purposes of this disclosure a “system on chip” (SoC) is an integrated circuit (IC) incorporating a plurality of sub system hardware components onto a single piece of silicon or other substrate. Sub systems can include central processing units, application processors, digital signal processors, modem processors, audio processors, graphics processing units, peripheral processors, camera processors, display processors, location processors and field programmable arrays (FPGAs), to name a few non-limiting examples. As used herein, a SoC can also refer to a system in package (SiP) or a system in which two or more substrates are stacked or otherwise coupled in a three-dimensional fashion, and wherein the two or more substrates are coupled via electrical connections such as ball bonds.

ARM uses a peripheral bridge between ASB/AHB (APSS and DSP) and the APB that peripherals couple to (e.g., UART and SPI). Hence the herein disclosed peripheral bus can be defined as any two or more buses linking the peripheral bus controller to a peripheral, and where a peripheral bridge or other bridge can link bus pairs.

For the purposes of this disclosure, a “network on chip” or “network on a chip” (NoC or NOC) is a communication subsystem on a SoC. A NoC is constructed from multiple point-to-point data links interconnected by switches (a.k.a. routers), such that messages can be relayed from any source module to any destination module over several links, by making routing decisions at the switches.

For the purposes of this disclosure, a “bus arbiter” or “arbiter” is a device used in a multi-master bus system to decide which bus master will be allowed to control the bus for each bus cycle. In some systems a centralized arbiter can be used (e.g., PCI) while in others the arbitration functionality can be distrusted amongst all nodes on the bus such that the nodes cooperate to decide who controls the bus next.

The word “exemplary” is used herein to mean “serving as an example, instance, or illustration.” Any embodiment described herein as “exemplary” is not necessarily to be construed as preferred or advantageous over other embodiments.

### Description

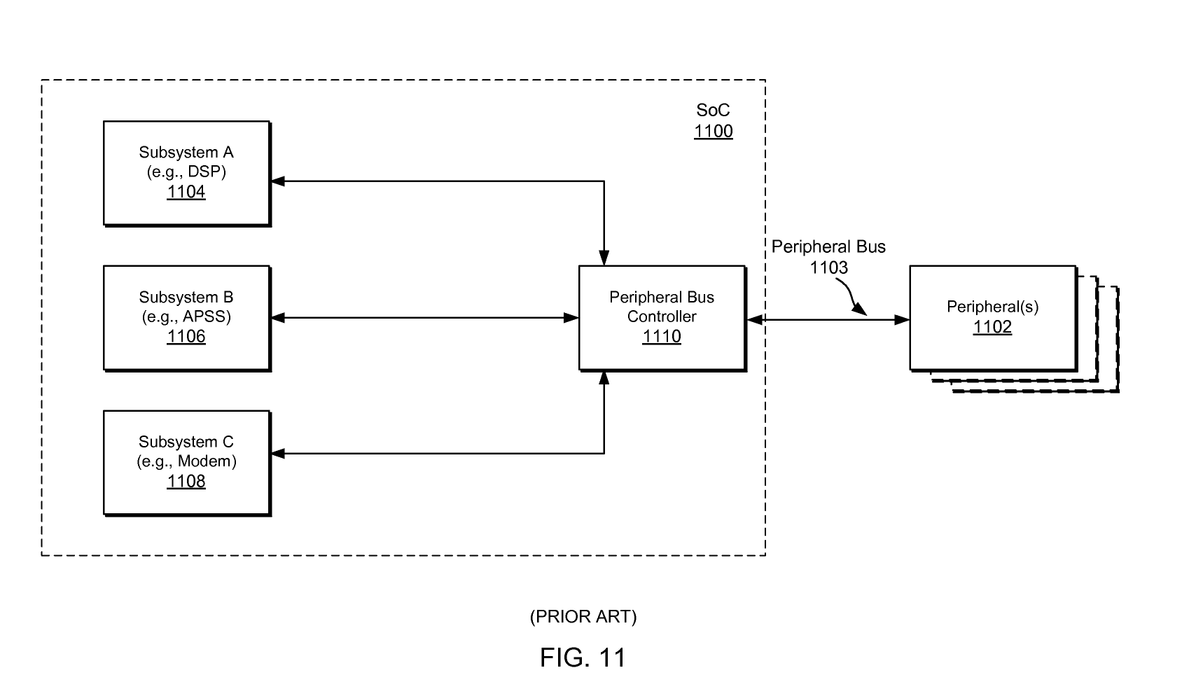

FIG. 11 illustrates an exemplary computing system for interfacing with one or more peripherals with a system on chip (SOC). The SOC 1100 includes a plurality of subsystems 1104, 1106, 1108, such as an applications processor (APSS) (of which there can be multiple APSS's), a digital signal processor (DSP), and a modem. One or more of these subsystem 1104, 1106, 1108 may attempt to access and/or control a peripheral bus 1103 in order to control the one or more peripherals 1102. To prevent errors or even physical damage that could occur should more than one subsystem 1104, 1106, 1108 access the peripheral bus 1103 at the same time, a peripheral bus controller 1110 is used to arbitrate control of the peripheral bus 1103. In other words, the peripheral bus controller 1110 determines which subsystem 1104, 1106, 1108 is the peripheral bus master and arbitrates this bus ownership between the subsystems 1104, 1106, 1108. Such arbitration is pre-wired into the peripheral bus controller 1110, and thus cannot be changed on the fly. For instance, the peripheral bus controller 1110 may be pre-wired such that subsystem B 1106 always has priority over all other subsystems 1104, 1108 in the event that multiple subsystems 1104, 1106, 1108 try to simultaneously control the peripheral bus 1103. Thus, determining which subsystem controls the peripheral bus is hardwired into the system and cannot be changed in real-time or based on changing circumstances such as different power saving modes or the appearance of different peripherals 1102 on the peripheral bus 1103.

As a further example, a peripheral bus controller 1110 may be pre-wired to always give bus ownership priority to an applications processor (APSS), and the peripheral bus 1103 may couple the APSS to a peripheral such as a touchscreen display. Inputs from the touchscreen display are then always handled by the APSS, which is a power hungry resource, and also prevents the APSS from focusing on other system tasks. Another peripheral bus controller 1110 may be pre-wired to always give bus ownership priority to a DSP, thereby conserving power. However, where the DSP processes data from the touchscreen display, it lacks the processing power of the APSS, and thus the DSP may have to pass some touchscreen display inputs to the APSS, thus adding complexity and delay. Hence, in the context of processing inputs from a touchscreen display, there are advantages to an APSS and a DSP owning a peripheral bus transferring data from the touchscreen display, but because arbitration schemes in the peripheral bus controller are pre-wired, only the APSS or the DSP can process data from the touchscreen display.

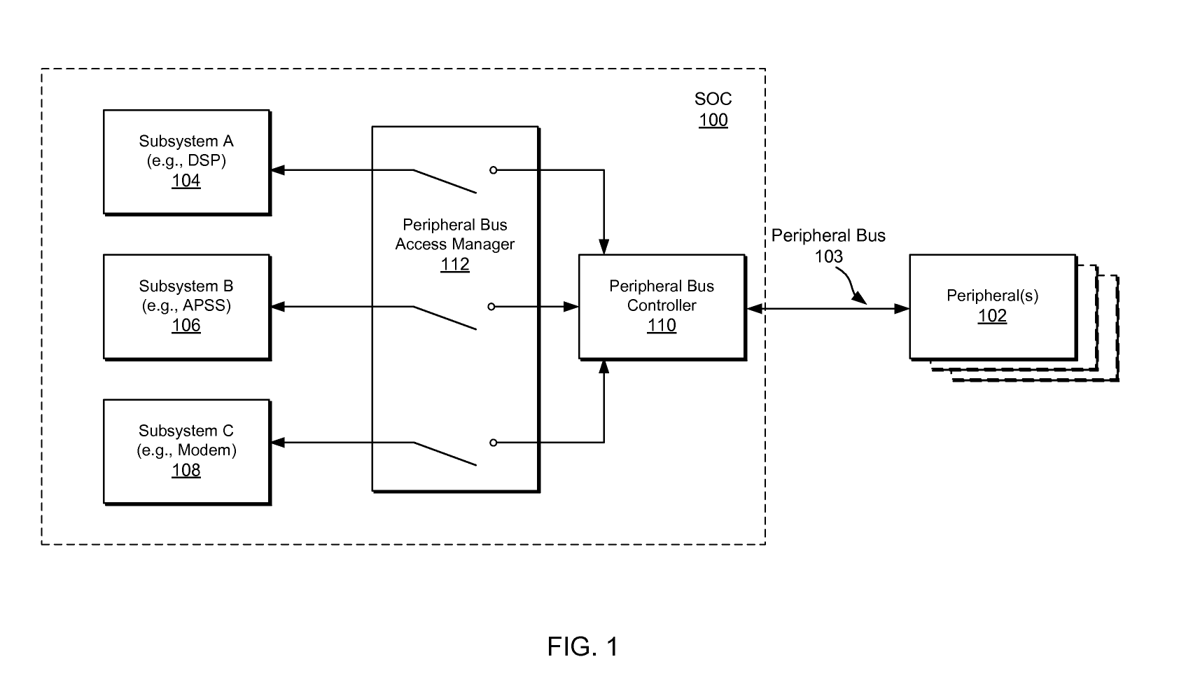

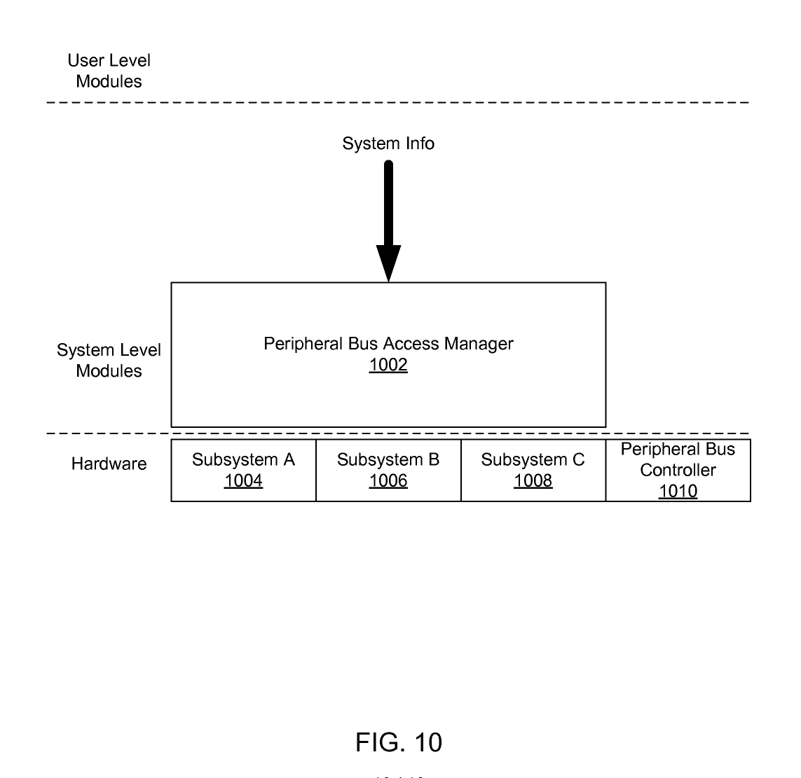

This disclosure describes systems, methods, and apparatus that enable dynamic switching of peripheral bus ownership at a higher level in the ‘stack’ (see FIG. 10) than the peripheral bus controller, thus providing a dynamic and controllable arbitrage system that operates before requests for bus control reach the peripheral bus controller and hence before the peripheral bus controller can carry out its pre-wired bus arbitrage. In other words, a peripheral bus access manager (distributed between subsystems and/or having various instances arranged on each of the subsystems) can be used to dynamically (in real time) limit access to the peripheral bus controller such that a peripheral bus controller's arbitrage between competing subsystems becomes virtually unused. FIG. 1 illustrates one such system.

FIG. 1 illustrates a functional diagram of a peripheral bus access manager managing the access of multiple subsystems to a peripheral bus controller responsible for arbitrating control of a peripheral bus coupled to one or more peripherals external to a SoC. In the illustrated embodiment, the peripheral bus controller 110 of the SoC 100 is pre-wired with an arbitration scheme, just as in the prior art. Thus, if requests from multiple subsystems 104, 106, 108 were to simultaneously reach the peripheral bus controller 110 (i.e., the peripheral bus access manager 112 did not exist), then the peripheral bus controller 110 would determine which subsystem 104, 106, 108 is to be master of the peripheral bus 103 and peripheral(s) 102 based on a hardcoded scheme. However, here, a peripheral bus access manager 112 performs its own master selection before such requests can reach the peripheral bus controller 110, and then only allows one of the subsystems 104, 106, 108 to access the peripheral bus controller 110 at a time. In other words, the peripheral bus controller 110 does not perform arbitration relative to requests from the subsystems 104, 106, 108, because from its perspective, only a single request to own the peripheral bus 103 arrives at the peripheral bus controller 110. Said another way, the peripheral bus access manager 112 performs its own arbitration that overshadows and preempts the hardwired arbitration of the peripheral bus controller 110. Thus, selecting a master for the peripheral bus 103 is not limited by the hardwired arbitrage schemes of the peripheral bus controller 110, but instead is more flexible and dynamic than prior art bus access and control schemes.

The following provides an implementation example to help show the importance of this innovation. System information, such as load balancing information, can be used to determine whether a first or second subsystem should be the master. In particular, load balancing information may determine whether an APSS or a DSP should own the peripheral bus 103 at any instant. Such system information is not available to the peripheral bus controller 110, a hardware component, and thus the peripheral bus controller 110 cannot select a peripheral bus master based on such information. With the addition and use of the peripheral bus access manager 112, a peripheral bus master can be assigned based on system information not available to the peripheral bus controller 110.

Turning briefly to FIG. 10, one sees a stack diagram showing the arrangement of the peripheral bus access manager 1002 (e.g., 112), multiple subsystems 1004, 1006, 1008 (e.g., 104, 106, 108), and the peripheral bus controller 1010 (e.g., 110) in the stack. User level modules reside at a top of the stack, hardware components at the bottom. System level modules reside between the user level modules and the hardware and act as interfaces between the user level modules and the hardware. The peripheral bus access manager 1002 can be distributed between two or more of the subsystems 1004, 1006, 1008, and/or can include instances of itself, where one instance is arranged on each of the subsystems 1004, 1006, 1008.

System information is available at the system level. System information can include a subsystem power model, a use case model, and a latency model, to name three non-limiting examples. An example of information in the subsystem power model is data indicating how much current the system draws at a particular frequency. An example of information in the use case model is a streaming frequency for streamed media, where this frequency can be used to determine how many APSS cores are needed to handle the incoming stream. An example of information in the latency model could indicate whether data to be processed by the APSS needs immediate attention or not, thus indicating whether that data can be offloaded to other cores or subsystems for processing.

The peripheral bus access manager 1002 has access to the system information since it resides at the system level. It can therefore determine which subsystem 1004, 1006, 1008 should be master of a peripheral bus based on the system information. This gives the peripheral bus access manager 1002 the ability to make more dynamic and more informed decisions about peripheral bus ownership than the peripheral bus controller 1010, which is limited to knowledge available at the hardware level.

Returning to FIG. 1, the peripheral bus controller 110 can act as a master for various bus protocols (e.g., I²C and SPI). In other words, the peripheral bus controller 110 is configured to select a bus protocol and carry out procedures for communicating on the peripheral bus 103 required by that protocol. This may require transformation of data going to or from the master subsystem, but does not change the fact that the master subsystem ultimately sends and receives data on the peripheral bus 103. In other words, the peripheral bus controller 110 is like a traffic cop directing traffic on the peripheral bus 103, but not ultimately using the peripheral bus 103. Said another way, the peripheral bus controller 110 is responsible for arbitrating activities to the right of the peripheral bus controller 110 in the illustration, while the peripheral bus access manager 112 is responsible for arbitrating activities to the left of the peripheral bus controller 110.

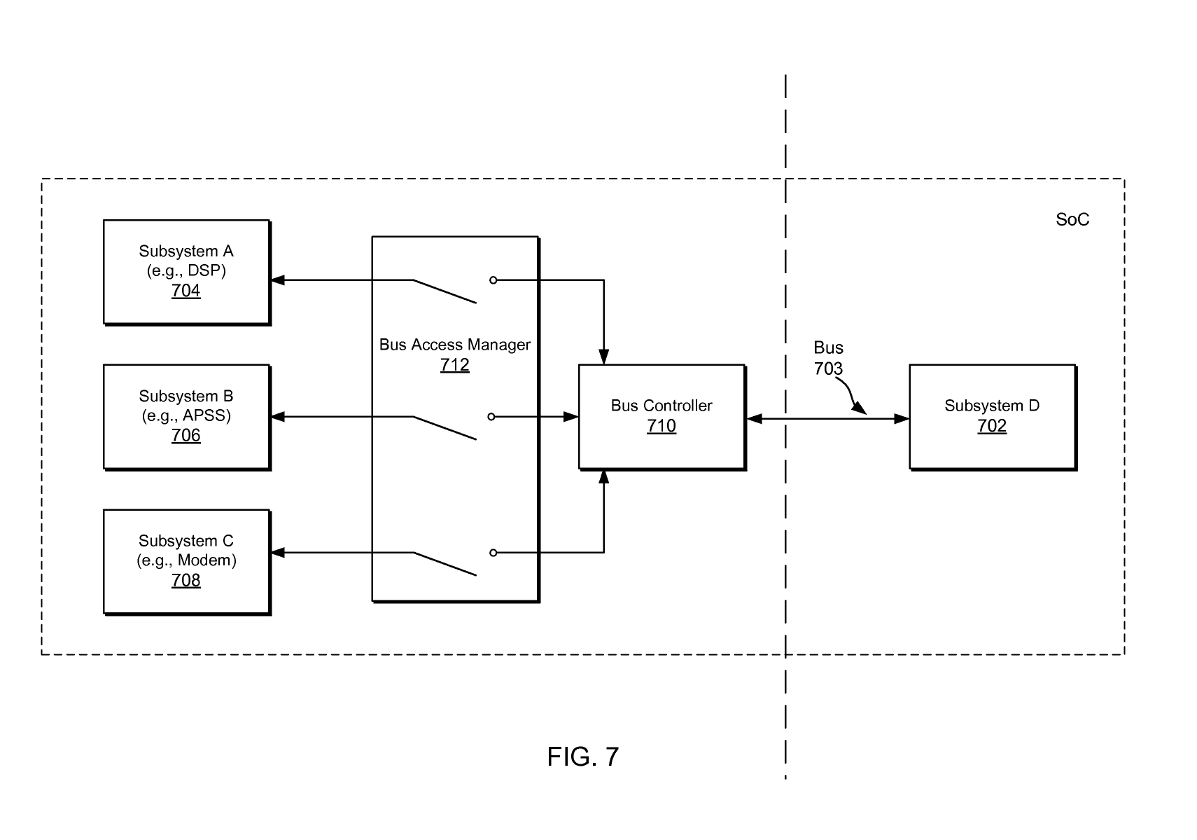

The peripheral bus controller 110, the peripheral bus access manager 112, and the subsystems 104, 106, 108 can all reside on a SoC 100. The one or more peripherals 102 can be external to the SoC. However, and as discussed relative to FIG. 7, the systems, methods, and apparatus herein disclosed are also applicable to ownership of a bus controller that acts as a master to a bus coupling the peripheral bus controller to another subsystem of the same SoC. In other words, there is no requirement that the systems, methods, and apparatus herein disclosed be applied to peripheral bus ownership or systems that are external to the SoC (see, e.g., FIG. 7). However, for the sake of a more concrete description of the disclosure, most of the disclosure will focus on embodiments where a peripheral bus and one or more peripherals external to the SoC are implemented.

The subsystems 104, 106, 108 can also be referred to as an execution environment since a peripheral's 102 data is typically limited to execution in a single execution environment (i.e., in a single subsystem). However, the ability for the peripheral bus access manager 112 to selectively control which subsystem 104, 106, 108 owns the peripheral bus 103 and the one or more peripherals 102, beyond the peripheral bus controller's 110 hardwired arbitrage scheme, means that data from a peripheral 102 can be processed in two or more execution environments. Without the peripheral bus access manager 112, the peripheral bus controller's 110 hardwired arbitrage scheme would dictate which subsystem 104, 106, 108 processed data from the peripheral(s) 102, and thus there would be no ability to switch which subsystem 104, 106, 108 processed this data in flight (i.e., without a change to the hardwired arbitrage scheme of the peripheral bus controller 110). For instance, data from a GPS subsystem or peripheral can initially be processed by a first subsystem (e.g., a CPU), but then be switched to processing on a second subsystem (e.g., a DSP) in real time due to load balancing demands on the first and second subsystems. Prior art systems required the peripheral bus master for the GPS subsystem to be selected during manufacturing or during programming of the peripheral bus controller 110, and thus inflight changes to this preference were not possible.

The peripheral bus controller 110 couples the plurality of subsystems 104, 106, 108 to the peripheral 102 via the peripheral bus 103. In some cases, multiple peripherals 102 may be linked to the peripheral bus 103, and different bus specifications (e.g., I²C, SPI, UART) may be needed to communicate with different peripherals. Therefore, the peripheral bus controller 110 may also be configured to translate communications from whichever subsystem 104, 106, 108 is the master to a given bus specification needed to speak with a given peripheral 102.

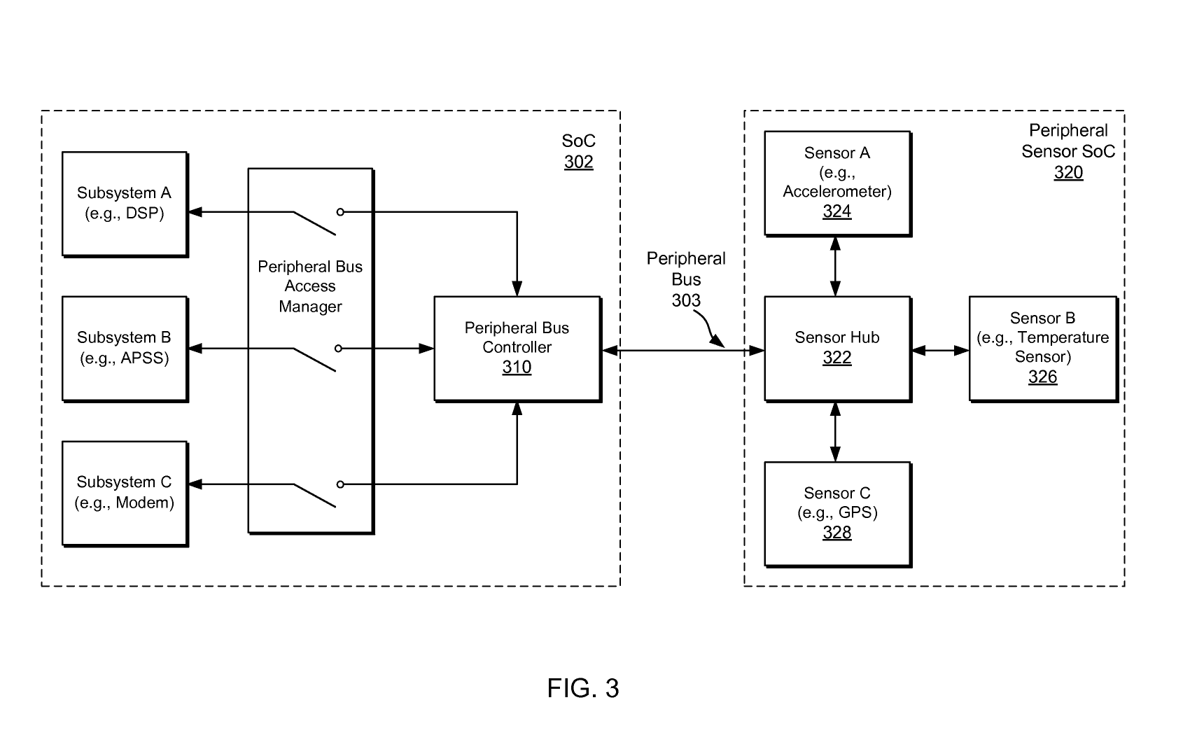

FIG. 3 illustrates a further embodiment of a SoC having a peripheral bus access manager managing the access of multiple subsystems to a peripheral bus controller. The SoC 302 is identical to that of FIG. 1, but here showing one implementation of the peripheral(s) 102 in FIG. 1. In particular, the SoC 302 is coupled to a peripheral sensor SoC 320 via a peripheral bus. The peripheral bus couples to a sensor hub 322 of the peripheral sensor SoC 320, where the sensor hub 322 is a hub for a plurality of sensors 324, 326, 328.

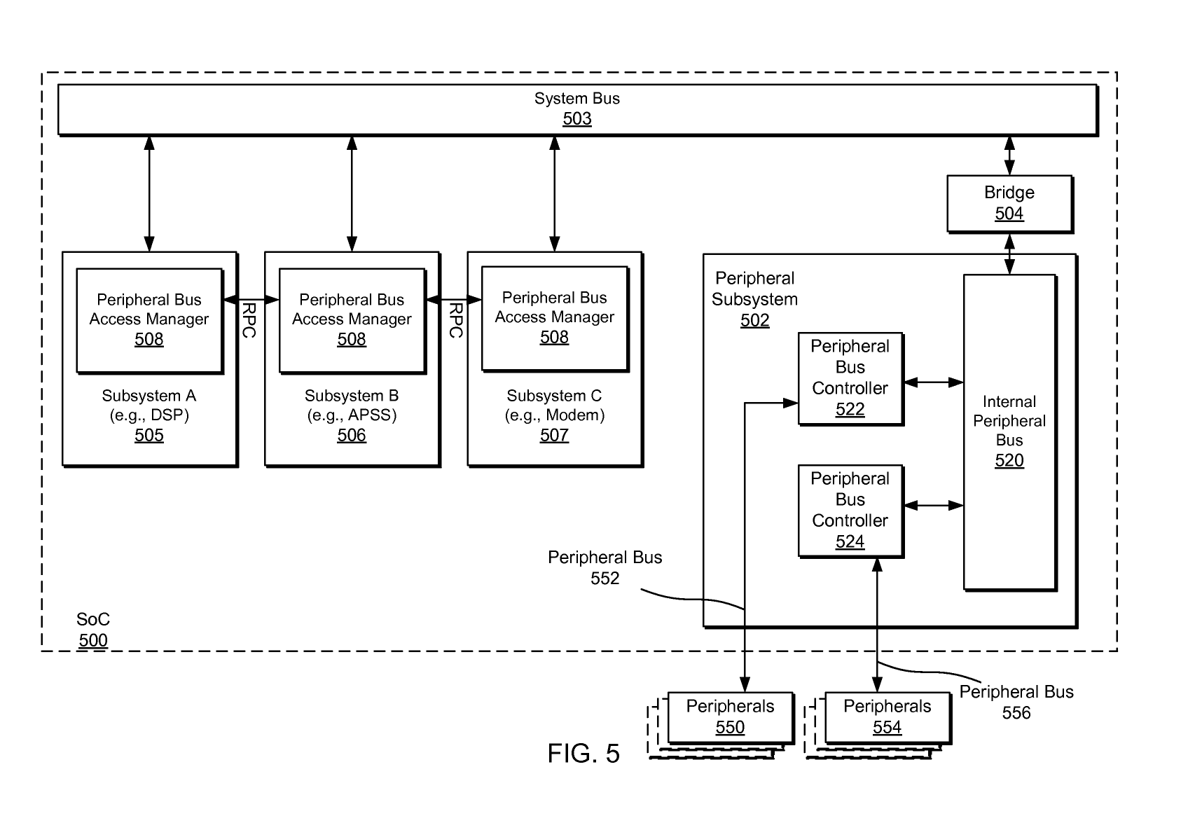

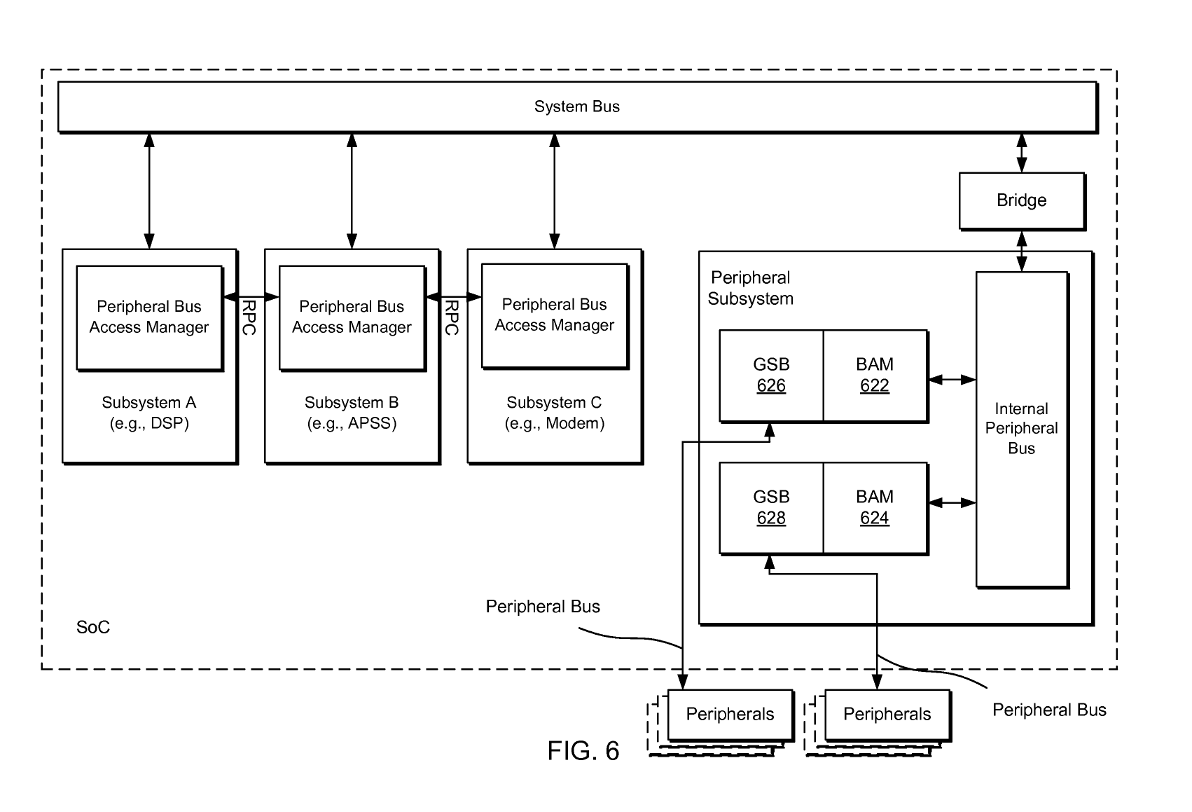

Although FIGS. 1 and 3 show a single peripheral bus 103, 303 between the peripheral bus controller 110, 310 and the one or more peripherals 102 or peripheral sensor SoC 320, in some embodiments, the peripheral bus 103, 303 can be replaced by a system bus linked to a peripheral bus via a bridge. The bridge is a master to the one or more peripherals, and one of various subsystems coupled to the system bus is a master to all sub-systems directly coupled to the system bus. A bridge is a component that interfaces two different buses such as a system and peripheral bus. FIGS. 5 and 6 illustrate examples of such an architecture and will be discussed later in this disclosure. The advanced microcontroller bus architecture is one implementation of the systems shown in FIGS. 5 and 6.

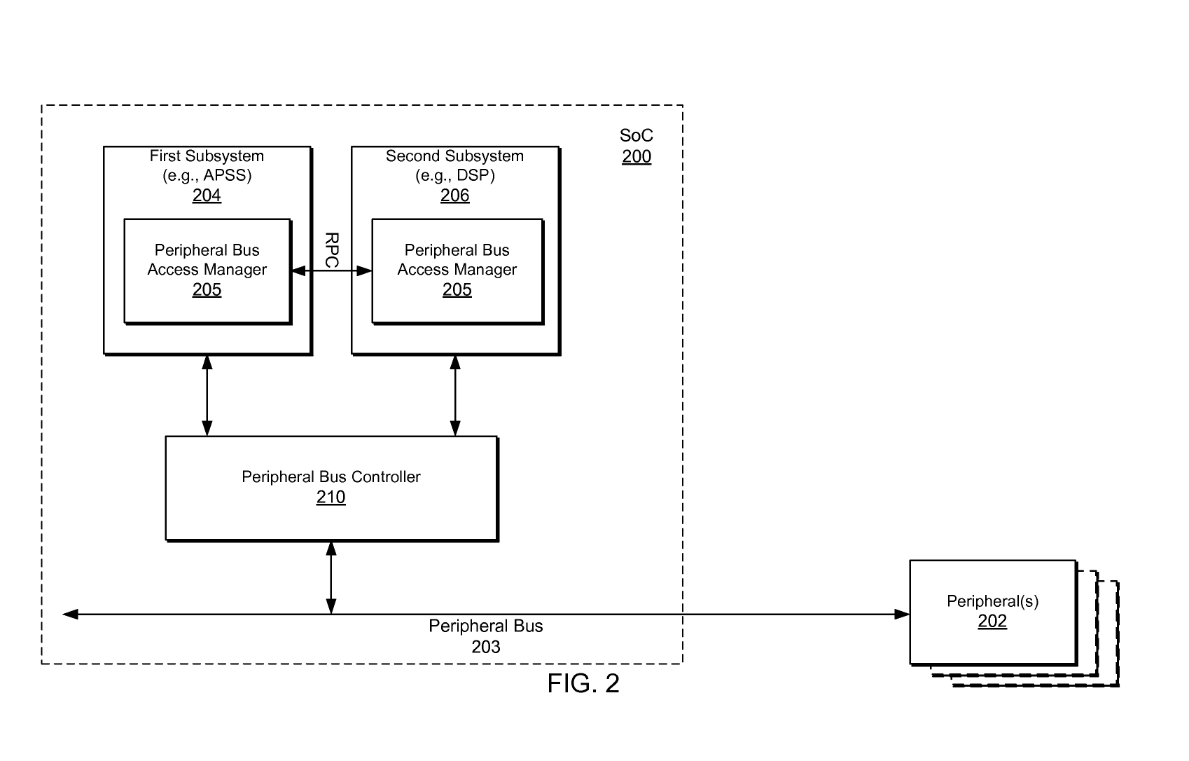

FIG. 2 illustrates a system diagram showing various components of an embodiment implemented to carry out the functionality described in FIG. 1. The peripheral bus access manager 112 is distributed on the subsystems 104, 106, 108, as seen by the first and second instances of the peripheral bus access manager 205 residing on a first and second subsystem 204, 206. The first and second instances of the peripheral bus access manager 205 arbitrate which of the first and second subsystems 204, 206 has access to the peripheral bus controller 210, and does so via remote procedure calls (RPCs) between the first and second instances of the peripheral bus access manager 205, and hence between the first and second subsystems 204, 206. It should be noted that since such requests can be passed via RPC and via the first and second instances of the peripheral bus access manager 205, the path of the requests can circumvent the peripheral bus controller 210. In the prior art, the peripheral bus controller 210 is always involved in switches between subsystems owning the peripheral bus. Here, one sees, that the peripheral bus controller 210 is somewhat cut out of the switching process. At initialization, one of the first and second subsystems 204, 206 starts with access to the peripheral bus controller 210. For instance where an applications processor APSS or CPU is implemented, the first and second instances of the peripheral bus access manager 205 will typically give default access to the APSS or CPU. From there on out, the first and second instances of the peripheral bus access manager 205 arbitrate access to the peripheral bus controller 210, and thus effectively arbitrate which subsystem is master over the peripheral bus 203 and peripherals 202 on the peripheral bus 203. While first and second instances of the peripheral bus access manager 205 are illustrated and described, in another embodiment, a peripheral bus access manager can be distributed between the first and second subsystems 204, 206 and in some cases this embodiment overlaps with a situation in which a first and second instance of the peripheral bus access manager 205 are arranged on the first and second subsystems.

When a need is seen to switch ownership of the peripheral bus 203, the first subsystem 204 sends a request to the second subsystem 206 via the first and second instances of the peripheral bus access manager 205 and in particular via a remote procedure call sent between the two instances of the peripheral bus access manager 205, to switch ownership of the peripheral bus 203. The first and second instances of the peripheral bus access manager 205 determine if such a switch is possible, and if so, they let the first subsystem 204 know that the switch is possible. The first and second instances of the peripheral bus access manager 205 then switch access to the peripheral bus controller 210 from the first subsystem 204 to the second subsystem 206. The second subsystem 206 is now in control of the peripheral bus 203 and all peripherals 202 on the peripheral bus 203. Switching back occurs in a similar fashion. Typically, the first subsystem (e.g., an APSS) determines when switching of bus ownership is desired, but the first and second instances of the peripheral bus access manager 205 govern the switch.

The first and second instances of the peripheral bus access manager 205 can be implemented as a new module on each subsystem. In one instance, if the peripheral bus access manager 205 is distributed across two subsystems, then an instance of the peripheral bus access manager 205 can be arranged on each of the two subsystems. In one example, where a peripheral bus access manager is to be arranged on an APSS, a new LINUX kernel module can be added to kernel space to implement this instance of the peripheral bus access manager 205 and its related functionality. Implementation of the herein described functionality also can include modification of peripheral bus drivers (e.g., SPI and I²C drivers) to release their resources in a synchronous fashion with the peripheral bus 203 transactions. In contrast, the prior art release method was asynchronous and thus did not guarantee that resources would be released if control of the bus switches to a different master. In other words, even if the prior art attempted to make a real time switch of bus ownership, it is possible that the bus and peripherals would not have released their resources when the switch occurred leading to errors and possible system failure.

Although the peripheral bus access manager 205 can be distributed across multiple subsystems, in some embodiments, the peripheral bus access manager 205 may have slightly different implementations on different subsystems (i.e., different instances on different subsystems). For example, where the peripheral bus access manager 205 is distributed across an APSS and a DSP, different code may be used on the instance arranged on the APSS than the code used on the instance arranged on the DSP. In other words, the functionality of the peripheral bus access manager 205 can be distributed across multiple instances, each instance arranged on a different subsystem. Thus, variations in instances of the peripheral bus access manager 205 across subsystems are envisioned by this disclosure.

FIG. 5 illustrates another system diagram for an embodiment to carry out the functionality described above. A SoC 500 includes a plurality of subsystems 505, 506, 507 that are all coupled to a system bus 503. A peripheral subsystem 502 includes an internal peripheral bus 520 having two peripheral bus controllers 522, 524 connected thereto. The system bus 503 and the peripheral bus 520 are interfaced via a bridge 504. This architecture is exemplified in ARM-type SoCs. The peripheral bus controllers 522, 524 each couple to one or more peripherals 550, 554 via respective peripheral buses 552, 556.

Relative to a given one of the peripheral buses 552, 556, the instances of the peripheral bus access manager 508 initialize such that one of the subsystems 505, 506, 507 has access to a respective peripheral bus controller 522, 524. Whichever one of the subsystem 505, 506, 507, starts with access to a respective peripheral bus controller 522, 524, typically is also responsible for determining when a switch of peripheral bus 552, 556 ownership is desired. When this is the case, that subsystem 505, 506, 507, may make a request to its respective instance of the peripheral bus access manager 508 for a switch of ownership and indicate a desired new owner of the peripheral bus 552, 556. The request is passed between the subsystems 505, 506, 507 via a remote procedure call, and if possible, the instances of the peripheral bus access manager 508 switch access to a respective peripheral bus controller 522, 524. Once the access is switched, the subsystem 505, 506, 507 with the access is also the master of the peripheral bus 552, 556 that the respective peripheral bus controller 522, 524 is responsible for.

In the illustrated peripheral subsystem 502, there are two peripheral bus controllers 522, 524, but in other embodiments there can be one or more of these peripheral bus controllers 522, 524.

While the functional and system diagrams of FIGS. 1-5 are not limited to any specific implementation, application to power saving implementations is particularly interesting. Because of the hardwired nature of peripheral bus controller arbitration and because a peripheral bus controller does not have knowledge of information at higher levels of the stack, a peripheral bus controller cannot dynamically change subsystem ownership of a peripheral bus with the goal of reducing power consumption. The present disclosure allows switching of peripheral bus ownership for the purpose of selecting a subsystem that most efficiently utilizes power at a given time, for a given task, and in a way that accounts for other loads being placed on other subsystems.

FIG. 6 illustrates yet another embodiment of a system diagram having hardware for carrying out the functionality above, but including a variation on the peripheral bus controllers 522, 524 of FIG. 6. In particular, a combination of a Bus Access Manager (BAM) (e.g., data mover) 622, 624 and a Generic Serial Block (GSB) 626, 628, form a BAM Low Speed Peripheral (BLSP). The Generic Serial Blocks can be configured to operate as I²C or SPI bus masters, or masters of any other peripheral bus protocol. Each Generic Serial Block can sit behind a BAM. The illustrated embodiment includes two Generic Serial Blocks 626, 628, and there can be six Generic Serial Blocks per BLSP.

One implementation of the systems shown in FIGS. 5 and 6 is for switching ownership of an SPI/I²C bus and all peripherals of that bus from one execution environment to another (e.g., from APSS to DSP). A more specific examples is to switch ownership of a touch screen controller from processing on a high power APSS or CPU to processing on a low power DSP.

FIG. 7 illustrates yet a further embodiment of a SoC that can dynamically switch peripheral bus controller access and hence dynamically switch bus ownership. Here, a bus controller 710 arbitrates a bus 703 connecting one of subsystems 704, 706, 708 to a fourth subsystem 702. All four subsystems 702, 704, 706, 708 are on a SoC. While the bus controller 710 is hardwired to arbitrate control of the bus 703, a bus access manager 712 can selectively allow access for one of the subsystems 704, 706, 708 to the bus controller 710, thereby effectively controlling which subsystem 704, 706, 708 controls the bus 703. The bus access manager 712 can be distributed across the subsystems 704, 706, 708, for example including an instance of the bus access manager 712 arranged on each of the subsystems 704, 706, 708.

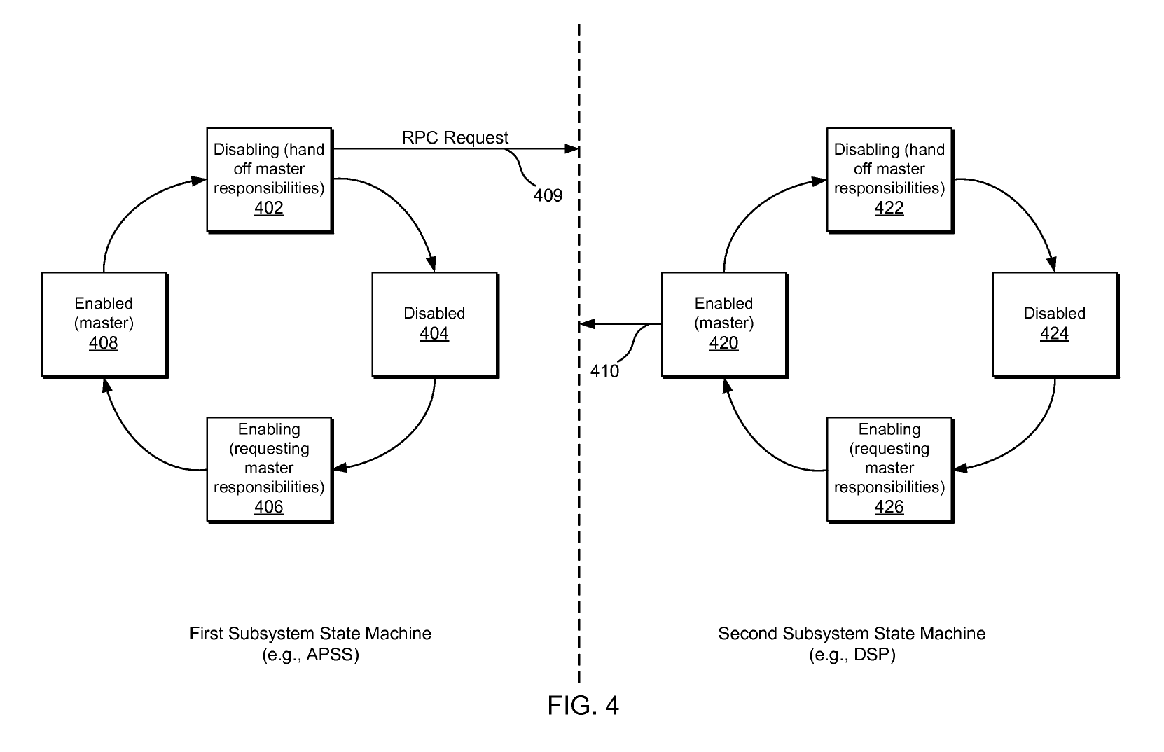

FIG. 4 illustrates a state diagram for a first and second subsystem as envisioned by this disclosure. The first subsystem can initialize with access to the peripheral bus controller, and hence as the master (408) of the peripheral bus, while the second subsystem initializes without access to the peripheral bus controller and hence in an idle or disabled state (424). The first subsystem then determines that a change of bus ownership is desired, and can request that the second subsystem take ownership of the bus via a remote procedure call (RPC) (409). The first subsystem can also begin disabling (402) and hand off master responsibilities so that the second subsystem can be enabled as the master (420) of the peripheral bus controller. Once enabled (420), the second subsystem can pass an indication back to the first subsystem letting it know that it is enabled as the master (410). The first subsystem can then complete disabling of its master role (404). The second subsystem now has access to the peripheral bus controller and hence access and control over the peripheral bus that the peripheral bus controller is responsible for.

Subsequently, the first subsystem can request to regain master status (406) with another RPC and begin the process of enabling as the master. The second subsystem will then start disabling (422), and once disabled, pass an indication of that it is disabled to the first subsystem, thereby handing off master responsibilities. Once the first subsystem receives this indication, the first subsystem will be enabled as the master (408) once again.

The RPC request (409) and the indication from the second subsystem (410) can both be made to a peripheral bus access manager such as 112, 205, or 312 in FIGS. 1-3.

FIG. 4 shows the switching between masters of the peripheral bus, and how the peripheral bus access manager facilitates this switching by switching subsystem access to the peripheral bus controller. For instance, an application processor may start with access to the peripheral bus controller and hence as the master, have oversight of a computing system. Based on load balancing initiatives or other reasons, the application processor may decide that control over a peripheral bus should be handed over to another subsystem, such as a DSP. One instance where this might occur is where the application processor decides that processing of touchscreen inputs through a peripheral bus can be handled by a DSP in order to save power. The application processor can then request that the DSP take ownership of the peripheral bus, and hence processing of inputs from the touchscreen, thus freeing the application processor for other duties (e.g., duties that a DSP or other subsystems are not tailored for). The request passes to the peripheral bus access manager, which then switches access to the peripheral bus controller. While this illustration looks at situations where a first subsystem instructs the second subsystem to take ownership of the bus, in an alternative embodiment, the second subsystem can request to take over master status from the first subsystem.

In one embodiment, the RPCs can be made with QMI, which is a QUALCOMM proprietary messaging protocol that exposes various functionalities of MSM.

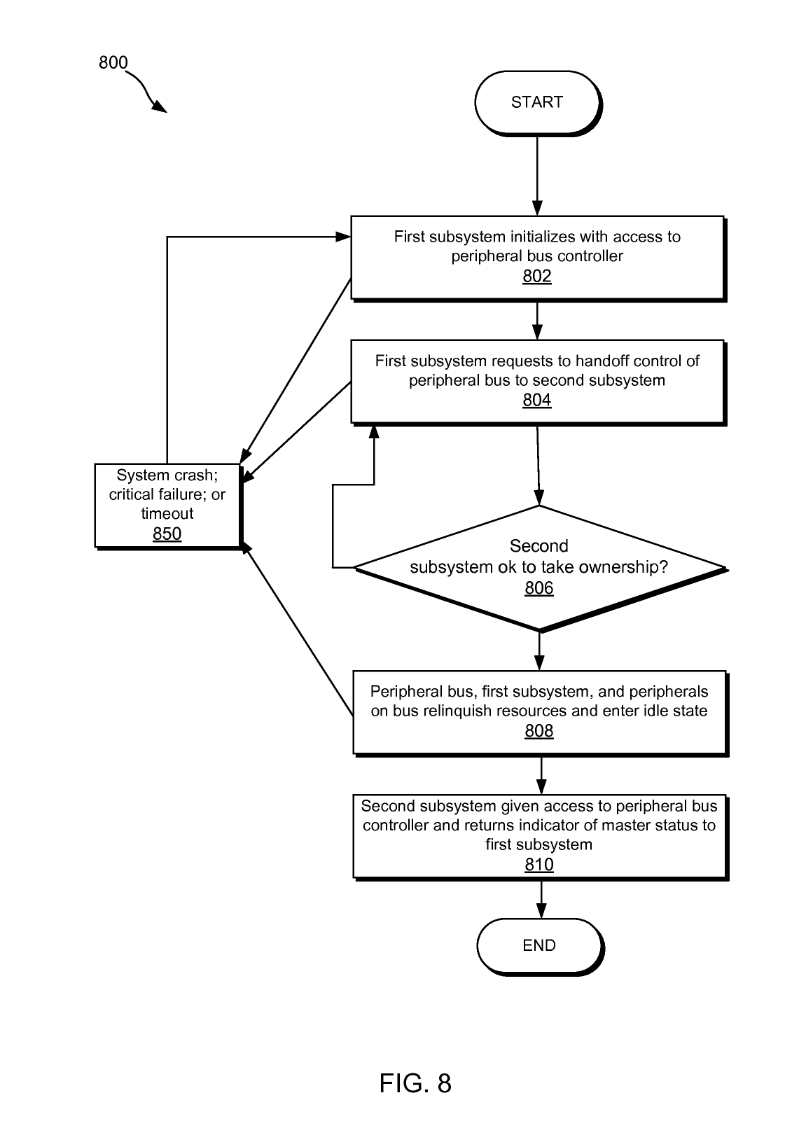

FIG. 8 illustrates a method of switching ownership of a bus where a master is selected from two or more subsystems and another subsystem(s) or peripheral(s) is(are) the slave. The method 800 starts by initializing a first and second subsystem, such as a CPU and DSP, for instance. One of the two subsystems initializes with access to a peripheral bus controller (Block 802), and hence processes data from peripherals on the peripheral bus (e.g., the first subsystem is the master of the peripheral bus). In some instances, the method 800 can start with the first subsystem as the master without initialization of the first and second subsystems. The first subsystem then determines that bus ownership should be handed off to the second subsystem and requests that the second subsystem take control of the peripheral bus (Block 804). In an embodiment, this request can be made via a remote procedure call between instances of a peripheral bus access manager (e.g., 112, 205, 508, 712) and/or a peripheral bus access manager distributed between the two subsystems, as described earlier. The method 800 then determines if the second subsystem is ok to take ownership of the bus and the slave subsystem(s) and/or peripheral(s) (Decision 806). If not, then the method 800 loops back to the first subsystem's request for ownership handoff (Block 804). Before a peripheral bus (e.g., SPI/I2C) and all its peripherals can switch subsystem ownership, the peripherals and bus must be in an idle state. In order to enter an idle state, the peripherals and bus release their resources and acquire them on the subsystem that takes ownership. Resources can include, but are not limited to, clocks, regulators, GPIOs, interrupts, bus voting and Trust Zone (TZ) xPUs (i.e. memory protection unit). When the second subsystem is ready, the bus and slave subsystem(s) and/or peripheral(s) relinquish resources and enter an idle state (Block 808). The method 800 then switches bus ownership to the second subsystem by giving peripheral bus controller access to the second subsystem, effectively enabling the second subsystem as the master of the peripheral bus and causing data from the peripherals to be processed by the second subsystem (Block 810). The second subsystem also informs the first subsystem that the ownership switch is complete (Block 810). The method 800 can operate in a similar manner for switching of bus ownership from the second subsystem to the first subsystem. Further, if at any time during the method 800, a system crash, critical failure, or timeout occurs (Block 850), then the peripheral bus controller can automatically grant peripheral bus controller access to the first system and revoke access to the second subsystem, thereby returning the first subsystem to master status.

One or more aspects of this method 800 can be implemented via a peripheral bus access manager distributed between two or more subsystems and/or via instances of a peripheral bus access manager, each instance arranged on a different one of two or more subsystems.

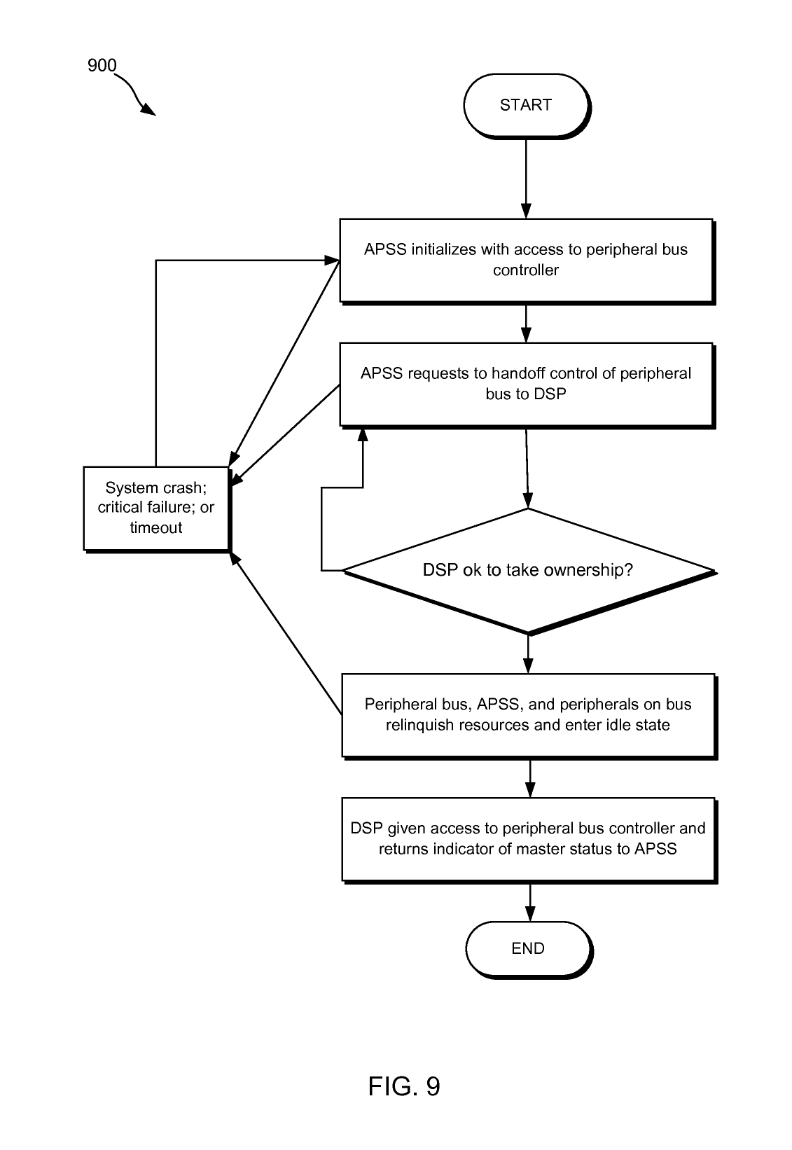

FIG. 9 illustrates an alternative method to the method 800 shown in FIG. 8. The method 900 replaces the first and second subsystems with an APSS and DSP, respectively.

It will be understood by one of skill in the art, that even though FIGS. 8 and 9 illustrate methods 800 and 900 having a particular order, that other orders of operation are similarly envisioned without departing from the scope and spirit of this disclosure.

Although this disclosure has primarily been described in the context of a shared bus topology for the peripheral bus, application to hierarchical bus and ring bus topologies are equally applicable.

The herein disclosed systems, methods, and apparatus are applicable to various arbitration schemes including static-priority, time division multiple access, lottery, and token passing.

The above discussion can be applied to a variety of bus architectures including, but not limited to, advanced microcontroller bus architecture (AMBA), Avalon, CoreConnect, STBus, Wishbone, CoreFrame, Manchester Asynchronous Bus for Low Energy, PI Bus, Open Core Protocol, Virtual Component Interface, and SiliconBackplane μNetwork.

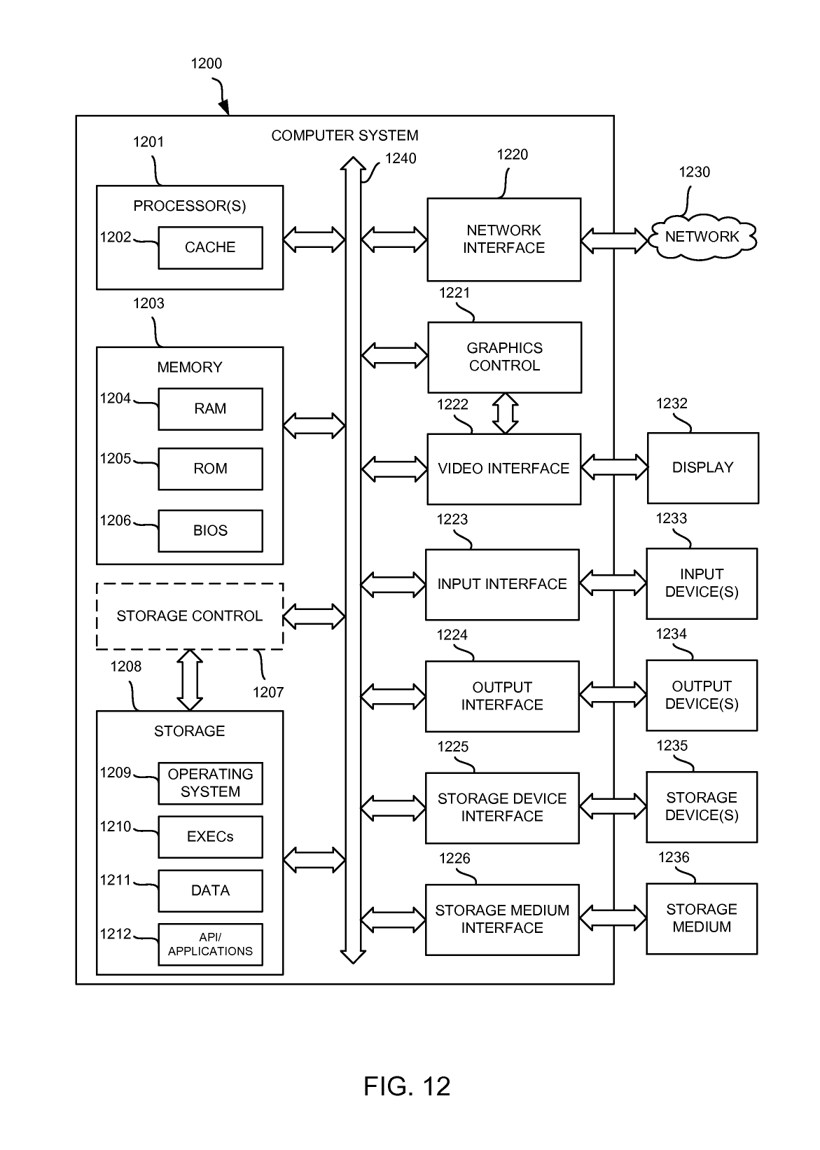

The systems and methods described herein can be implemented in a computer system in addition to the specific physical devices described herein. FIG. 12 shows a diagrammatic representation of one embodiment of a computer system 1200 within which a set of instructions can execute for causing a device to perform or execute any one or more of the aspects and/or methodologies of the present disclosure. A computer comprising the SoC 100 in FIG. 1 is one implementation of the computer system 1200. The components in FIG. 12 are examples only and do not limit the scope of use or functionality of any hardware, software, firmware, embedded logic component, or a combination of two or more such components implementing particular embodiments of this disclosure. Some or all of the illustrated components can be part of the computer system 1200. For instance, the computer system 1200 can be a general purpose computer (e.g., a laptop computer) or an embedded logic device (e.g., an FPGA), to name just two non-limiting examples.

Computer system 1200 includes at least a processor 1201 such as a central processing unit (CPU) or an FPGA to name two non-limiting examples. Any of the subsystems described throughout this disclosure could embody the processor 1201. The computer system 1200 may also comprise a memory 1203 and a storage 1208, both communicating with each other, and with other components, via a bus 1240. The bus 1240 may also link a display 1232, one or more input devices 1233 (which may, for example, include a keypad, a keyboard, a mouse, a stylus, etc.), one or more output devices 1234, one or more storage devices 1235, and various non-transitory, tangible computer-readable storage media 1236 with each other and with one or more of the processor 1201, the memory 1203, and the storage 1208. All of these elements may interface directly or via one or more interfaces or adaptors to the bus 1240. For instance, the various non-transitory, tangible computer-readable storage media 1236 can interface with the bus 1240 via storage medium interface 1226. Computer system 1200 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 1201 (or central processing unit(s) (CPU(s))) optionally contains a cache memory unit 1202 for temporary local storage of instructions, data, or computer addresses. Processor(s) 1201 are configured to assist in execution of computer-readable instructions stored on at least one non-transitory, tangible computer-readable storage medium. Computer system 1200 may provide functionality as a result of the processor(s) 1201 executing software embodied in one or more non-transitory, tangible computer-readable storage media, such as memory 1203, storage 1208, storage devices 1235, and/or storage medium 1236 (e.g., read only memory (ROM)). For instance, the methods 800 and 900 in FIGS. 8 and 9 may be embodied in one or more non-transitory, tangible computer-readable storage media. The non-transitory, tangible computer-readable storage media may store software that implements particular embodiments, such as the methods 800 and 900, and processor(s) 1201 may execute the software. Memory 1203 may read the software from one or more other non-transitory, tangible computer-readable storage media (such as mass storage device(s) 1235, 1236) or from one or more other sources through a suitable interface, such as network interface 1220. Any of the subsystems herein disclosed could include a network interface such as the network interface 1220. The software may cause processor(s) 1201 to carry out one or more processes or one or more steps of one or more processes described or illustrated herein. Carrying out such processes or steps may include defining data structures stored in memory 1203 and modifying the data structures as directed by the software. In some embodiments, an FPGA can store instructions for carrying out functionality as described in this disclosure (e.g., the methods 800 and 900). In other embodiments, firmware includes instructions for carrying out functionality as described in this disclosure (e.g., the methods 800 and 900).

The memory 1203 may include various components (e.g., non-transitory, tangible computer-readable storage media) including, but not limited to, a random access memory component (e.g., RAM 1204) (e.g., a static RAM “SRAM”, a dynamic RAM “DRAM, etc.), a read-only component (e.g., ROM 1205), and any combinations thereof. ROM 1205 may act to communicate data and instructions unidirectionally to processor(s) 1201, and RAM 1204 may act to communicate data and instructions bidirectionally with processor(s) 1201. ROM 1205 and RAM 1204 may include any suitable non-transitory, tangible computer-readable storage media described below. In some instances, ROM 1205 and RAM 1204 include non-transitory, tangible computer-readable storage media for carrying out the methods 800 and 900. In one example, a basic input/output system 1206 (BIOS), including basic routines that help to transfer information between elements within computer system 1200, such as during start-up, may be stored in the memory 1203.

Fixed storage 1208 is connected bidirectionally to processor(s) 1201, optionally through storage control unit 1207. Fixed storage 1208 provides additional data storage capacity and may also include any suitable non-transitory, tangible computer-readable media described herein. Storage 1208 may be used to store operating system 1209, EXECs 1210 (executables), data 1211, API applications 1212 (application programs), and the like. For instance, the storage 1208 could be implemented for storage of system information that can be used to determine which subsystem should be given access to the peripheral bus controller at any given time as described in FIG. 10. Often, although not always, storage 1208 is a secondary storage medium (such as a hard disk) that is slower than primary storage (e.g., memory 1203). Storage 1208 can also include an optical disk drive, a solid-state memory device (e.g., flash-based systems), or a combination of any of the above. Information in storage 1208 may, in appropriate cases, be incorporated as virtual memory in memory 1203.

In one example, storage device(s) 1235 may be removably interfaced with computer system 1200 (e.g., via an external port connector (not shown)) via a storage device interface 1225. Particularly, storage device(s) 1235 and an associated machine-readable medium may provide nonvolatile and/or volatile storage of machine-readable instructions, data structures, program modules, and/or other data for the computer system 1200. In one example, software may reside, completely or partially, within a machine-readable medium on storage device(s) 1235. In another example, software may reside, completely or partially, within processor(s) 1201.

Bus 1240 connects a wide variety of subsystems. Herein, reference to a bus may encompass one or more digital signal lines serving a common function, where appropriate. Bus 1240 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1200 may also include an input device 1233. In one example, a user of computer system 1200 may enter commands and/or other information into computer system 1200 via input device(s) 1233. Examples of an input device(s) 1233 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 1233 may be interfaced to bus 1240 via any of a variety of input interfaces 1223 (e.g., input interface 1223) including, but not limited to, serial, parallel, game port, USB, FIREWIRE, THUNDERBOLT, or any combination of the above.

In particular embodiments, when computer system 1200 is connected to network 1230, computer system 1200 may communicate with other devices, such as mobile devices and enterprise systems, connected to network 1230. Communications to and from computer system 1200 may be sent through network interface 1220. For example, network interface 1220 may receive incoming communications (such as requests or responses from other devices) in the form of one or more packets (such as Internet Protocol (IP) packets) from network 1230, and computer system 1200 may store the incoming communications in memory 1203 for processing. Computer system 1200 may similarly store outgoing communications (such as requests or responses to other devices) in the form of one or more packets in memory 1203 and communicated to network 1230 from network interface 1220. Processor(s) 1201 may access these communication packets stored in memory 1203 for processing.

Examples of the network interface 1220 include, but are not limited to, a network interface card, a modem, and any combination thereof. Examples of a network 1230 or network segment 1230 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 1230, may employ a wired and/or a wireless mode of communication. In general, any network topology may be used.

Information and data can be displayed through a display 1232. Examples of a display 1232 include, but are not limited to, a liquid crystal display (LCD), an organic liquid crystal display (OLED), a cathode ray tube (CRT), a plasma display, and any combinations thereof. The display 1232 can interface to the processor(s) 1201, memory 1203, and fixed storage 1208, as well as other devices, such as input device(s) 1233, via the bus 1240. The display 1232 is linked to the bus 1240 via a video interface 1222, and transport of data between the display 1232 and the bus 1240 can be controlled via the graphics control 1221.

In addition to a display 1232, computer system 1200 may include one or more other peripheral output devices 1234 including, but not limited to, an audio speaker, a printer, and any combinations thereof. Such peripheral output devices may be connected to the bus 1240 via an output interface 1224. Examples of an output interface 1224 include, but are not limited to, a serial port, a parallel connection, a USB port, a FIREWIRE port, a THUNDERBOLT port, and any combinations thereof.

In addition or as an alternative, computer system 1200 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Within this specification, the same reference characters are used to refer to terminals, signal lines, wires, etc. and their corresponding signals. In this regard, the terms “signal,” “wire,” “connection,” “terminal,” and “pin” may be used interchangeably, from time-to-time, within the this specification. It also should be appreciated that the terms “signal,” “wire,” or the like can represent one or more signals, e.g., the conveyance of a single bit through a single wire or the conveyance of multiple parallel bits through multiple parallel wires. Further, each wire or signal may represent bi-directional communication between two, or more, components connected by a signal or wire as the case may be.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the methods 800 and 900) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A SoC arbitrating subsystem access to a peripheral bus controller, the SoC comprising:
a peripheral bus controller for managing data flow on a peripheral bus;
first and second subsystems coupled to the peripheral bus by the peripheral bus controller, the first subsystem initially having exclusive access to the peripheral bus and thereby processing data from one or more peripherals on the peripheral bus; and
a first instance of a peripheral bus access manager included by the first subsystem;
a second instance of the peripheral bus access manager included by the second subsystem;
the first and second instances comprising non-transitory, tangible computer readable storage media, encoded with processor readable instructions to perform a method for selecting which one of the first and second subsystems has access to the peripheral bus controller, the method comprising:
passing a request from the first subsystem to the second subsystem requesting that processing of the data from the one or more peripherals be switched to the second subsystem, a path of the request circumventing the peripheral bus controller; and
switching access to the peripheral bus controller from the first subsystem to the second subsystem, in response to the request, such that processing of the data from the one or more peripherals switches to the second subsystem.

2. The SoC of claim 1, wherein the first subsystem is an applications processor.

3. The SoC of claim 2, wherein the second subsystem is a digital signal processor.

4. The SoC of claim 1, wherein the one or more peripherals include at least one sensor.

5. The SoC of claim 1, wherein the one or more peripherals are external to the SoC.

6. The SoC of claim 1, wherein the one or more peripherals are on the SoC.

7. The SoC of claim 1, further comprising a remote procedure call connection between the first and second subsystems carrying the request that processing of the data from the one or more peripherals be switched to the second subsystem.

8. The SoC of claim 1, wherein the remote procedure call connection carries an indicator that switching of processing of the data from the first to the second subsystem is complete.

9. A method for arbitrating subsystem access to a peripheral bus controller, the method comprising:
managing, via a peripheral bus controller, data flow on a peripheral bus between a first subsystem and one or more peripherals;
processing data on the first subsystem from the one or more peripherals;
generating a request that the processing be switched to a second subsystem;
passing the request via a remote procedure call to the second subsystem via a path that circumvents the peripheral bus controller;
switching access to the peripheral bus controller from the first subsystem to the second subsystem, resulting in a switch in ownership of the peripheral bus from the first to the second subsystem; and
processing data on the second subsystem from the one or more peripherals.

10. The method of claim 9, wherein the first subsystem is an applications processor.

11. The method of claim 10, wherein the second subsystem is a digital signal processor.

12. The method of claim 9, wherein the one or more peripherals include at least one sensor.

13. The method of claim 9, wherein the one or more peripherals are external to a SoC comprising the first and second subsystems.

14. The method of claim 9, wherein the one or more peripherals are on a SoC comprising the first and second subsystems.

15. The method of claim 9, further comprising verifying that switching ownership of the peripheral bus from the first to the second subsystem can occur.

16. The method of claim 9, further comprising informing the first subsystem that ownership of the peripheral bus has been transferred to the second subsystem.

17. The method of claim 9, wherein the request is generated based in part on system information not available to the peripheral bus controller.

18. The method of claim 9, wherein the switch in ownership of the peripheral bus results from the switching of access to the peripheral bus controller rather than from running an arbitrating procedure of the peripheral bus controller.

19. A non-transitory, tangible computer readable storage medium, encoded with processor readable instructions to perform a method for arbitrating subsystem access to a peripheral bus controller, the method comprising:
managing, via a peripheral bus controller, data flow on a peripheral bus between a first subsystem and one or more peripherals;
processing data on the first subsystem from the one or more peripherals;
requesting that the processing be switched to a second subsystem;
passing this request via a remote procedure call to the second subsystem via a path that circumvents the peripheral bus controller;
switching access to the peripheral bus controller from the first subsystem to the second subsystem; and
processing data on the second subsystem from the one or more peripherals.
